(19) United States
(12) Patent Application Publication
(10) Pub. No.: US 2002/0093833 A1
(43) Pub. Date: Jul. 18, 2002

(54) Optically enhanced halogen curing light

(76) Inventor: John West, Arroyo Grande, CA (US)

Correspondence Address: W. Robinson H. Clark, Dorsey & Whitney LLP, Suite 300 South, 1001 Pennsylvania Avenue, N.W., Washington, DC, 20004, US

(21) Appl. No.: 09/994,812

(22) Filed: Nov. 28, 2001

Related U.S. Application Data
(60) Provisional application No. 60/253,085, filed on Nov. 28, 2000.
(60) Provisional application No. 60/262,102, filed on Jan. 18, 2001.

(51) Int. Cl. F21V 7/04

(52) U.S. Cl. 362/555; 362/572; 362/556; 362/574

(57) ABSTRACT

The present invention is directed to optically-enhanced light-emitting resin-curing devices and methods of applying these devices to the purpose of curing resins. This invention permits the use of conventional curing lights and allows for curing resins more rapidly. These curing devices typically include, a conventional curing light source, a lens assembly that focuses the light into a smaller diameter and an optical guide for delivery of the focused light to the resin.

### CROSS-REFERENCE TO RELATED APPLICATION

This application hereby claims the benefit of the priority of U.S. Provisional Patent Application, Serial No. 60/253,085, filed Nov. 28, 2000, and of U.S. Provisional Patent Application, Serial No. 60/262,102, filed Jan. 18, 2001, both of which are hereby incorporated by reference.

### BACKGROUND OF THE INVENTION

1. Field of the Invention

The present invention relates to a light-emitting, resin-curing device and a method of applying the light-emitting, resin-curing device to dental resins. More particularly, this invention relates to an optically-enhanced, halogen-light-based resin-curing device that is able to maximize the overall curing and curing rate of dental restorative materials and that allows for dental bleaching, all in a cost-efficient and timely manner.

2. Description of Related Art

The field of dentistry has evolved such that caries, cavities and other irregularities in a person's teeth can be bonded, sealed or filled with resins (which, in the present context, also include polymers). In view of this, the increasing use of resins to fill caries or to fix other dental irregularities has resulted in the need for quick-curing resins and for devices and methods that promote the efficient and quick curing of resins.

Specifically, the need for more efficient and better bonding or sealing materials has led to dental support companies producing high-quality resins and resinous materials. In addition to these high-quality resins and resinous materials, there has been an increased focus on curing the resins and resinous materials in a uniform manner to ensure that there is no shrinking or cracking.

The curing of the resins can be done with one of several available light-emitting, curing devices. However, the types of light-emitting, curing devices that are used today can be broken into two different categories: (i) conventional-light-emitting curing devices and (ii) high-intensity-light-emitting curing devices.

The conventional-light-emitting curing devices, that typically include tungsten halogen lamps or bulbs as the light source, have been used in the dental industry for a long time. These conventional-light-emitting curing devices typically have the advantages of long operable lifetimes, dependability and affordability.

Conventional-light-emitting curing devices cost substantially less than the more expensive, high-intensity-light-emitting curing devices. For example, a typical conventional-light-emitting curing device can cost as little as between $1,000 and $1,500. However, there are several drawbacks to the conventional-light-emitting curing devices.

Particularly, conventional-light-emitting curing devices require relatively long curing times. For example, it is common for a conventional-light-emitting curing device to take 30-40 seconds to cure resinous materials. In addition, conventional-light-emitting curing devices, such as those that make use of tungsten halogen lamps or bulbs, do not focus enough light energy (watts of power) into a small enough spot size to be transmitted through an optical path of approximately six feet in length. When such transmission is attempted, there is typically not enough energy to rapidly polymerize dental resins at the other end of the path. Rather, the tungsten halogen lamps or bulbs typically have to be positioned within inches of the final delivery point and typically cure photo-polymerizable resins with a small, unfocused cross-section of the total light emitted from the bulb.

Hence, the light source has to be operated at a higher power to make up for the unused portions of its total emitted light and conventional-light-emitting curing devices typically must be designed such that a cooling fan is placed close to the bulb. For the sake of convenience, the bulb and a cooling fan are generally built into a hand-held device. However, the hand-held device is noisy, vibrates and blows hot air. Since, in operation, the hand-held device is necessarily held in close proximity to the patient's face, the patient is exposed to unpleasant noise, vibrations and hot air from the hand-held device.

The high-intensity-light-emitting curing devices typically include xenon lamps or xenon short-arc lamps that produce greater light energy than the tungsten halogen lamps discussed above. However, the xenon lamps and short-arc lamps are much more expensive and complex in design than their lower-intensity counterparts.

Nonetheless, although high-intensity-light-emitting curing devices have only been on the market for about 4 or 5 years and cost approximately $4,000 to $4,500, such systems have gained a substantial measure of acceptance. This is in large part due to the fact that the lamps in the high-intensity light-emitting curing devices produce more light energy and therefore cure the restorative materials much faster, usually in as little as 10 seconds, and often in as little as approximately 3 to 5 seconds.

The disadvantages of these high-intensity-light-emitting curing devices are that the power supplies required to ignite the lamps are expensive, the light system is complex and the finished product is highly priced.

### SUMMARY OF THE INVENTION

Certain embodiments of the present invention are directed to conventional-light-emitting, resin-curing devices that include a light source, a reflector surrounding the light source, and an optical lens configuration or optical system that provides focused light energy for curing dental materials and for other applications. These devices make use of assemblies that combine tungsten halogen light sources with an optical lens configuration that produces the same high-intensity light that is produced by relatively complex and expensive systems with high-intensity xenon curing lamps. The present invention may be described as optically-enhanced, halogen-light-emitting curing devices.

Curing dental materials is one application of the present invention. However, other embodiments of the invention include methods and devices, dental or otherwise, that focus light from a relatively low-intensity or low-energy light source into a focused spot of relatively high-intensity or high-energy light and that then propagate the focused light through an optical wave guide or optical fiber.

### BRIEF DESCRIPTION OF THE DRAWINGS

The present invention will be further described by FIGS. 1-3. These figures are solely intended to illustrate various preferred embodiments of the invention and are not intended to limit the scope of the invention in any manner.

FIG. 1 illustrates a schematic of an optically-enhanced, light-based curing device configuration according to a first embodiment of the present invention.

FIG. 2 illustrates a schematic of an optically-enhanced, light-based curing device according to a second embodiment of the present invention.

FIG. 3 provides specific dimensions and components for use in accordance with certain embodiments of the present invention.

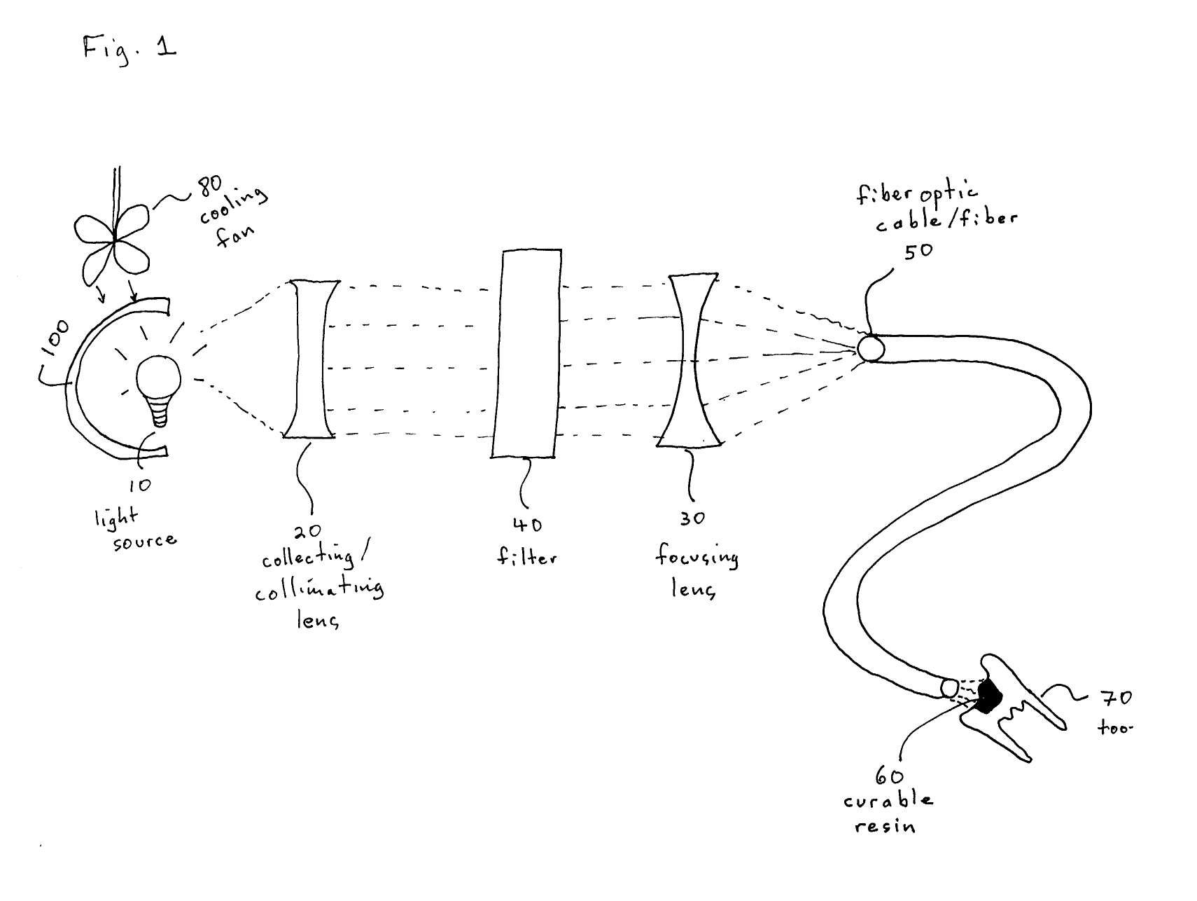

Same numerals in FIGS. 1-3 are assigned to similar elements in all the figures. Embodiments of the present invention are discussed below with reference to FIGS. 1-3. However, those skilled in the art will readily appreciate that the detailed description given herein with respect to these figures is for explanatory purposes as the present invention extends beyond these limited embodiments.

### DETAILED DESCRIPTION OF THE INVENTION

FIG. 1 illustrates a first embodiment of an optically-enhanced, light-emitting, resin-curing device. This embodiment includes a light source 10 in the form of a lamp, a first lens 20 in the form of a collecting/collimating lens, a filter 40, a second lens 30 in the form of a focusing lens, and an optical wave guide 50 (also referred to as a light guide). A reflector 100 is positioned around at least a portion of the light source 10 and reflects light from the light source 10 through an opening in the reflector 100. After leaving the reflector 100, the light travels through the first lens 20, the filter 40, and the second lens 30 and travels toward one end of the optical wave guide 50. The light enters the optical wave guide 50 and travels to the location of a curable resin 60 that is positioned in a tooth 70.

A fan 80 is positioned in close enough proximity to the device such that, when in operation, components of the resin-curing device may be cooled by the fan 80. The optical wave guide 50 has a proximal end that is adjacent to the second lens 30 and a distal end that is positioned adjacent to the light-curable resin 60 and tooth 70.

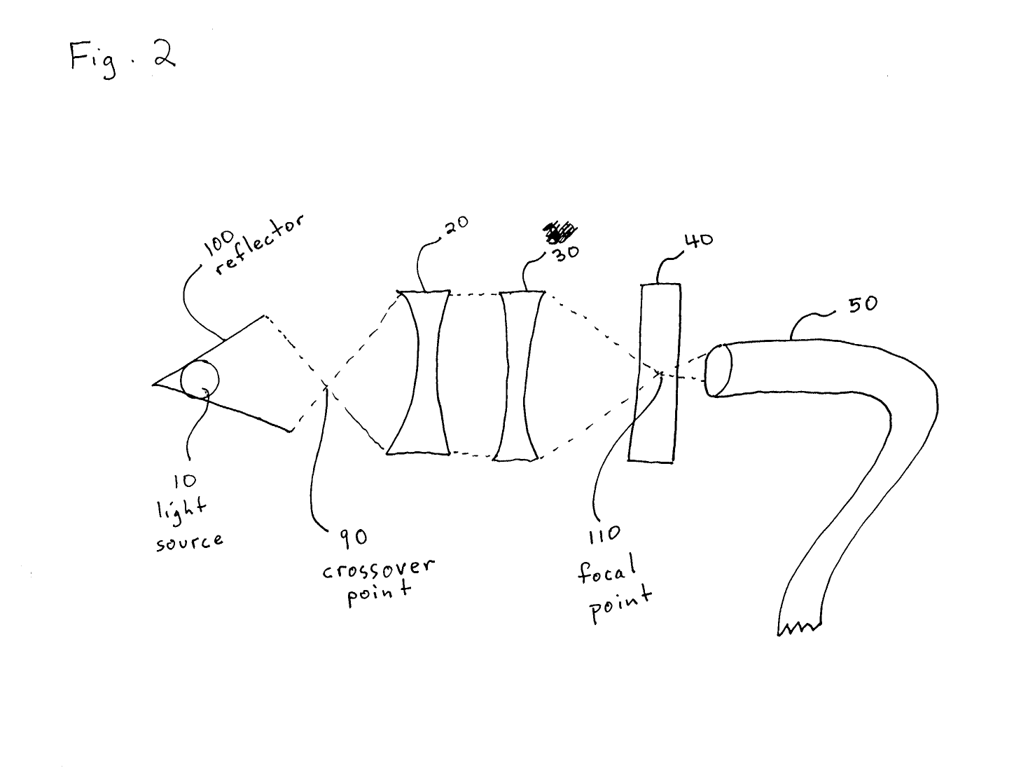

FIG. 2 illustrates a second embodiment of an optically-enhanced, light-emitting, resin-curing device according to the present invention. In this configuration, the reflector 100 focuses light from the light source 10 onto a collecting and collimating lens 20. The light then travels to a second lens 30, that focuses the light onto one end of the optical wave guide 50 after passing through the filter 40.

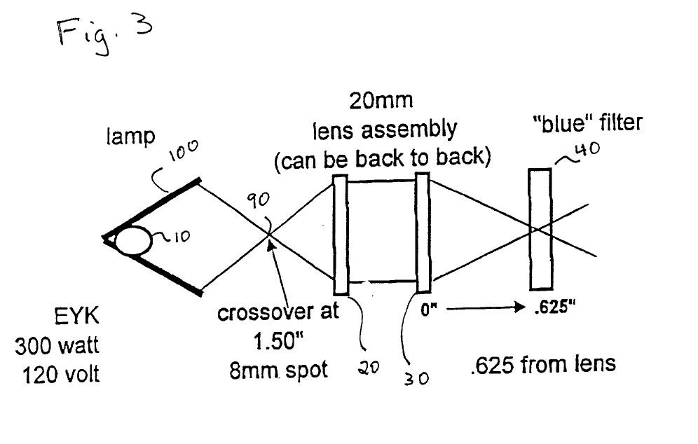

In FIG. 2, a crossover point 90 is illustrated as being positioned between the reflector 100 and the collecting and collimating lens 20. A focal point 110 is also shown in the interior of the filter 40. Representative locations and dimensions for some of the components illustrated in FIG. 2 are provided in FIG. 3, as are specifications for some other components.

According to certain embodiments of the present invention, the light source 10 can be a tungsten halogen lamp or other type of lamp. Preferably, a low-energy light source 10 is used such that the resin-curing device of the present invention needs no separate power supply and can be directly plugged into a wall outlet. The only requirement for the light source 10 is that it can be integrated into an optical assembly and focused to generate enough energy to cause rapid curing of the resin 60 or other similar material.

The collecting and collimating lens 20 in FIG. 1 collects a portion of the light that is emitted from the light source 10 and collimates it such that it is directed along the optical path. Once collimated, the light is passed through a filter 40 that typically only passes “blue” light between the wavelength ranges of 380 nm to 510 nm. The lens 20 in FIG. 2 may also pass the light through a filter 40 but this is done after the light passes through the focusing lens 30.

Either one or a collection of filters 40 may be used to select the optimal wavelengths of light for curing the resin 60. Hence, infra-red filters and/or ultra-violet filters (not shown) may be added with the understanding that each additional filter results in a loss of light intensity. Other optical components such as, but not limited to, polarizers, beam splitters, and mirrors (not shown), may also be used in the optical lens configuration.

According to certain embodiments of the present invention, the filter 40 is not needed because the light source 10 is not a lamp but instead is a source that only emits light in a certain wavelength range. For example, a cluster of light-emitting diodes (LEDs) or laser diodes that only emit at and around the wavelengths needed to cure the resin 60 may be used, eliminating the need for the filter 40.

The focusing lens 30 in FIG. 2 takes the collimated, filtered light and focuses it into a spot of relatively high-intensity light. A preferred focusing lens 30 is a 30 mm achromatic condensing lens. However, other lenses that may be used include, but are not limited to, aspheric condensing lenses and plano-concave-convex lenses.

Although the high-intensity light spot may be positioned directly onto the resin 60, it is preferable to position the spot on the end of a light-channeling device such as the optical wave guide 50. The optical wave guide 50 may be a fiber-optic cable or fiber. According to certain other embodiments of the present invention, the optical wave guide 50 may be replaced with other devices such as, but not limited to, a fiber-optic bundle, a liquid light guide, or a rigid light guide.

The optical wave guide 50 allows the dentist (or other operator) using the curing device to direct the light focused onto the proximal end of the optical wave guide 50 onto the resin 60 at a remote location. Preferably, the optical wave guide 50 is flexible, approximately six feet long, 7 millimeters or less in diameter, and allows the dentist to position the distal end of the optical wave guide 50 in close proximity to or directly on the curable resin 60 in a patient's tooth 70.

The light source 10, the collecting/collimating lens 20, the focusing lens 30, the filter 40 and a cooling fan 80 (used to regulate the temperature of the light source 10) are, according to certain embodiments of the present invention, placed within a hand-held device to which the optical wave guide 50 may be attached.

Ergonomic configurations for all of the components described above will become apparent to one skilled in the art upon practice of the present invention and are therefore not greatly detailed herein. The curing devices can be any reasonable size, but small hand-held devices are preferred. These devices can resemble a pistol, where the light source 10 is positioned very close (within inches) of the final delivery point (the resin). The apparatus illustrated in FIG. 1 of U.S. Pat. No. 5,147,204 to Patten et al., incorporated herein in its entirety by reference, shows one possible way of encasing the components of the present invention.

An advantage of the present invention is that it provides devices where light travels down the optical wave guide 50 that is quiet, compact, small, and easy to maneuver around. This is all achieved by using a light source 10 that generates light with enough power to travel down the length of a six-foot optical wave guide 50, and still has enough energy on the end of the guide 50 closest to the resin 60 to effect rapid curing.

Although the configuration illustrated in FIG. 2 includes a collimating lens 20, a focusing lens 30 and a filter 40, this configuration merely represents some of the possible embodiments of the present invention and is in no way limiting thereof. According to certain other embodiments, as little as a single lens may be used to collect and focus the light from the light source 10 into a smaller diameter, resulting in greater useful light intensity (energy) per cross-sectional area than is normally achieved. The lens 20, 30 described above can further be coated with any optical coatings that are well known in the art and that act as filters to selectively pass only a specific wavelength range of light.

The reflector 100 may include a reflective material positioned around the light source 10 such that light emitted away from the optical setup is redirected toward the collecting/collimating lens 20 shown in FIG. 2. Any reflective material may be used, though some materials will be superior to others, dependent on the wavelength of the light to be reflected in order to cure the resin 60. The reflector 100 is typically formed in a shape that reflects the greatest amount of light onto the lenses 20, 30 and includes an opening to allow light to travel out of the reflector 100.

A cross-over point 90 is illustrated in FIG. 2 between the light source 10 and the collecting/collimating lens 20. This is a point at which the maximum amount of light is focused before re-diffusing onto the surface of the collecting/collimating lens 20.

In the optical setup illustrated in FIG. 2, the filter 40 is positioned between the focusing lens 30 and the optical wave guide 50. Within the filter 40 is the focal point 110 of the focusing lens 30. This is the point at which the maximum amount of light is focused before re-diffusing onto the surface of the optical wave guide 50.

Experimental Data

Experiments have shown that dental resins cured utilizing the curing devices and methods discussed above are cured properly. The experiments included measurements of power on both power meters and light intensity meters. It was also demonstrated that embodiments of the invention are able to cure resinous materials 80% as fast as high-intensity light sources. Moreover, the curing devices of the present invention cure greater than twice as fast as conventional-light-emitting curing devices.

Several different dental restorative resins were tested utilizing a light-focusing assembly that included a tungsten halogen lamp, a condensing lens and a (M) filter. The lamp was an ELC 250 watt, 24 volt lamp. The lens assembly was a 30 mm achromatic condensing lens with a “blue” filter positioned 0.625″ from the lens. The lamp, when used in combination with this lens assembly, focuses down to an 8 mm spot. Curing tests to a 3 mm depth were conducted with the following results:

| Dental Restoratives | Curing Time |
|---|---|
| DenMat FloRestore Shad A1 | 3 seconds |
| DenMat FloRestore Shade A3.5 | 3 seconds |
| DenMat Virtuoso Condensable | 3 seconds |
| Ker Herculite | 5 seconds |

While the invention has been described in conjunction with the specific embodiments outlines above, it is evident that many alternatives, modifications, and variations will be apparent to those skilled in the art. Accordingly, the preferred embodiments of the invention are intended to be illustrative and not limiting. Various changes may be made without departing from the spirit and scope of the invention.

We claim the following:

1. A curing device comprising:
a light source;
a reflector positioned proximate to the light source and having an opening;
an optical lens configuration, positioned proximate to the opening; and
an optical wave guide positioned proximate to the optical lens configuration.

2. The device of claim 1, wherein the light source comprises a low-energy light source.

3. The device of claim 1, wherein the light source comprises at least one of a tungsten halogen lamp, a laser diode and a light-emitting diode.

4. The device of claim 1, wherein the optical lens configuration comprises an achromatic condensing lens.

5. The device of claim 1, wherein the optical lens configuration comprises a collecting and collimating lens.

6. The device of claim 1, further comprising a filter, positioned proximate to the optical lens.

7. The device of claim 6, wherein the filter is positioned between the optical lens configuration and an optical wave guide

8. The device of claim 6, wherein the filter transmits light of wavelengths between approximately 380 nm and 510 nm.

9. The device of claim 1, wherein the optical wave guide comprises a fiber-optic fiber.

10. The device of claim 9, wherein the fiber-optic fiber has a diameter of less than approximately 7 mm.

11. The device of claim 1, wherein the optical wave guide is flexible.

12. A method for curing a resin comprising:
reflecting light emitted by a light source towards an optical lens configuration;
collecting the light in the optical lens configuration;
focusing the light onto a first end of an optical wave guide; and
curing a resin at a second end of the optical wave guide using the light.

13. The method of claim 12, further comprising collimating the light in the optical lens configuration.

14. The method of claim 12, further comprising filtering the light before the light cures the resin.

15. The method of claim 14, wherein filtering the light comprises transmitting only the light with a wavelength between approximately 380 nm and 510 nm.
